(19) United States
(12) Patent Application Publication
(10) Pub. No.: US 2020/0400952 A1
(43) Pub. Date: Dec. 24, 2020

(54) LENS WITH INTERNAL APERTURE

(71) Applicant: Facebook Technologies, LLC, Menlo Park, CA (US)

(72) Inventors: Kurt Allen Jenkins, Sammamish, WA (US); Chad Lichtenhan, Issaquah, WA (US); Michael Patrick Schaub, Redmond, WA (US); Byron Taylor, Sammamish, WA (US)

(21) Appl. No.: 16/689,558

(22) Filed: Nov. 20, 2019

Related U.S. Application Data
(60) Provisional application No. 62/862,888, filed on Jun. 18, 2019.

(51) Int. Cl. G02B 27/01; B29D 11/00

(52) U.S. Cl. CPC G02B 27/0172; G02B 2027/0178; B29D 11/00442; B29D 11/0048

(57) ABSTRACT

A lens with an internal aperture includes a first region of optically-transmissive material, a second region of optically-transmissive material, and an internal aperture element. The first region of optically transmissive material defines a first surface of the lens and the second region defines a second surface of the lens that is opposite the first surface. The internal aperture element is integrally disposed between the first region and the second region and defines the aperture of the lens.

### CROSS-REFERENCE TO RELATED APPLICATION

The present application claims the benefit of U.S. Provisional Application No. 62/862,888, entitled “Lens Manufacturing and Assembly” filed Jun. 18, 2019. U.S. Provisional Application No. 62/862,888 is expressly incorporated herein by reference in its entirety.

### FIELD OF DISCLOSURE

Aspects of the present disclosure relate generally to lenses, and in particular but not exclusively, relate to lenses that include an internal aperture.

### BACKGROUND

A smart device is an electronic device that typically communicates with other devices or networks. In some situations the smart device may be configured to operate interactively with a user. A smart device may be designed to support a variety of form factors, such as a head mounted device, a head mounted display (HMD), or a smart display, just to name a few.

Smart devices may include one or more electronic components for use in a variety of applications, such as gaming, aviation, engineering, medicine, entertainment, video/audio chat, activity tracking, and so on. For example, a smart device may include an electronic display for generating image light, a camera for capturing images of the user and/or environment, and/or a light emitting device for illuminating the user and/or environment. Thus, a smart device may also include one or more optical assemblies for use in conjunction with the electronic component. Such optical assemblies may include a variety of optical elements, such as lenses, polarizers, waveguides, reflectors, waveplates, etc., that are configured to pass, direct, filter, and/or focus light to or from the electronic component.

The size requirements of the various optical assemblies may be dependent on the particular application. Thus, as the need for the miniaturization and/or accuracy of the smart device increases, the need for the miniaturization and accuracy of the various optical assemblies also increases.

### BRIEF DESCRIPTION OF THE DRAWINGS

Non-limiting and non-exhaustive aspects of the present disclosure are described with reference to the following figures, wherein like reference numerals refer to like parts throughout the various views unless otherwise specified.

FIG. 1 illustrates a head mounted display (HMD), in accordance with aspects of the present disclosure.

FIGS. 2A-2D illustrate an example lens with an internal aperture, in accordance with aspects of the present disclosure.

FIG. 3 is a flow chart illustrating an example process of fabricating a lens with an internal aperture, in accordance with aspects of the present disclosure.

FIG. 4 is a flow chart illustrating an example two-shot process of fabricating a lens with an internal aperture element, in accordance with aspects of the present disclosure.

FIGS. 5A-5F illustrate an example implementation of the two-shot process of FIG. 4.

FIG. 6 is a flow chart illustrating an example one-shot process of fabricating a lens utilizing a removable internal aperture element, in accordance with aspects of the present disclosure.

FIGS. 7A-7F illustrate an example implementation of the one-shot process of FIG. 6.

FIG. 8 is a flow chart illustrating an example two-shot process of fabricating a lens utilizing a removable internal aperture element, in accordance with aspects of the present disclosure.

FIGS. 9A-9F illustrate an example implementation of the two-shot process of FIG. 8.

FIG. 10 is a flow chart illustrating an example process of fabricating an internal aperture for a glass lens, in accordance with aspects of the present disclosure.

FIGS. 11A-11D illustrate an example implementation of the process of FIG. 10.

### DETAILED DESCRIPTION

Various aspects and embodiments are disclosed in the following description and related drawings to show specific examples relating to a lens with an internal aperture. Alternate aspects and embodiments will be apparent to those skilled in the pertinent art upon reading this disclosure and may be constructed and practiced without departing from the scope or spirit of the disclosure. Additionally, well-known elements will not be described in detail or may be omitted so as to not obscure the relevant details of the aspects and embodiments disclosed herein.

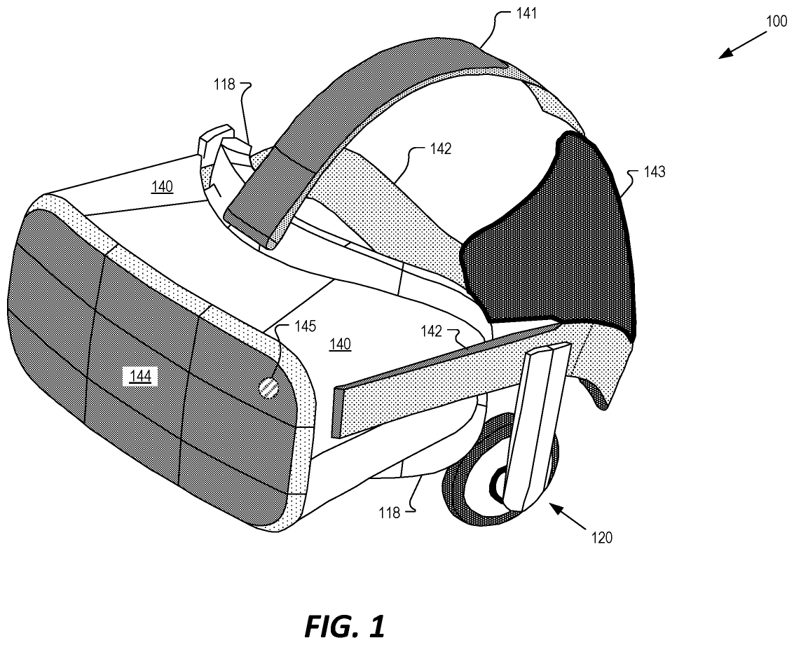

FIG. 1 illustrates a head-mounted display (HMD) 100, in accordance with aspects of the present disclosure. An HMD, such as HMD 100, is one type of smart device, typically worn on the head of a user to provide artificial reality content to a user. Artificial reality is a form of reality that has been adjusted in some manner before presentation to the user, which may include, e.g., virtual reality (VR), augmented reality (AR), mixed reality (MR), hybrid reality, or some combination and/or derivative thereof. The illustrated example of HMD 100 is shown as including a viewing structure 140, a top securing structure 141, a side securing structure 142, a rear securing structure 143, and a front rigid body 144. In some examples, the HMD 100 is configured to be worn on a head of a user of the HMD 100, where the top securing structure 141, side securing structure 142, and/or rear securing structure 143 may include a fabric strap including elastic as well as one or more rigid structures (e.g., plastic) for securing the HMD 100 to the head of the user. HMD 100 may also optionally include one or more earpieces 120 for delivering audio to the ear(s) of the user of the HMD 100.

The illustrated example of HMD 100 also includes an interface membrane 118 for contacting a face of the user of the HMD 100, where the interface membrane 118 functions to block out at least some ambient light from reaching to the eyes of the user of the HMD 100.

Example HMD 100 may also include a chassis for supporting hardware of the viewing structure 140 of HMD 100 (chassis and hardware not explicitly illustrated in FIG. 1). The hardware of viewing structure 140 may include any of processing logic, wired and/or wireless data interface for sending and receiving data, graphic processors, and one or more memories for storing data and computer-executable instructions. In one example, viewing structure 140 may be configured to receive wired power and/or may be configured to be powered by one or more batteries. In addition, viewing structure 140 may be configured to receive wired and/or wireless data including video data.

Viewing structure 140 may include a display system having one or more electronic displays for directing light to the eye(s) of a user of HMD 100. The display system may include one or more of a liquid crystal display (LCD), an organic light emitting diode (OLED) display, a micro-LED display, etc. for emitting light (e.g., content, images, video, etc.) to a user of HMD 100. The viewing structure 140 may also include an optical assembly that is configured to receive the image light from the display system and generate a virtual image (e.g., by collimating the image light) for viewing by an eye of a wearer of the HMD 100. In some embodiments, the optical assembly included in the viewing structure 140 may include a variety of near-eye optical elements, such as one or more of a lens, a polarizer, a waveguide, a reflector, a waveplate, and so on. In some implementations of the disclosure, the term “near-eye” may be defined as including an element that is configured to be placed within 50 mm of an eye of a user while a near-eye device is being utilized. Therefore, a “near-eye optical element” or a “near-eye system” would include one or more elements configured to be placed within 50 mm of the eye of the user.

In some examples, an electronic component 145 may be included in viewing structure 140. In some aspects, the electronic component 145 is a camera or image sensor for capturing image(s) of an eye of a user of HMD 100 for eye-tracking operations. In other aspects, the electronic component 145 is a Simultaneous Localization and Mapping (SLAM) sensor, such as an optical sensor, rangefinder, LiDAR sensor, sonar sensor, etc., for mapping the user and/or environment surrounding the HMD 100. In other examples, electronic component 145 may be a laser or other light-emitting device.

In some aspects, the electronic component 145 may be mated with an optical assembly that includes one or more small-diameter optical elements, such as a lens, a polarizer, a waveguide, reflector, a waveplate, etc. In some aspects, a “small-diameter” optical element refers to an optical element having a diameter (e.g., aperture) that is 3 millimeters or less.

As mentioned above, as the requirements for the miniaturization of the various systems (e.g., eye-tracking system or viewing structure) of an HMD increases, so too does the need to reduce the size of the optical assemblies and/or optical elements that may be utilized.

Conventional optical assembly mounting techniques include mating various optical elements together, such as in a barrel, housing, or frame, which in turn provides the alignment of the various optical elements with respect to one another. Conventional optical assemblies may include a lens and a separate aperture or aperture stop. An aperture is a hole or opening through which light travels and may be utilized within an optical assembly to control the cone angle, the depth of field, optical aberrations, stray light, etc. However, the aperture stop and lens included in conventional optical assemblies are typically provided as separate and discrete optical elements. Mating a lens with a separate aperture in an optical assembly may require precise alignment, which may complicate the assembly process. In addition, providing a lens and aperture, each as discrete optical elements, increases the overall size of the optical assembly.

Accordingly, aspects of the present disclosure provide for a lens that is fabricated to include an internal aperture. As will be described in more detail below, a lens with an internal aperture may be fabricated as a single monolithic structure. Having a lens with an internal aperture may increase the tolerance precision as compared to the conventional structures described above that include the aperture and lens being separate discrete optical elements. In addition, a lens with an internal aperture may eliminate the need for a separate aperture to be included in the optical assembly, thus reducing the overall size.

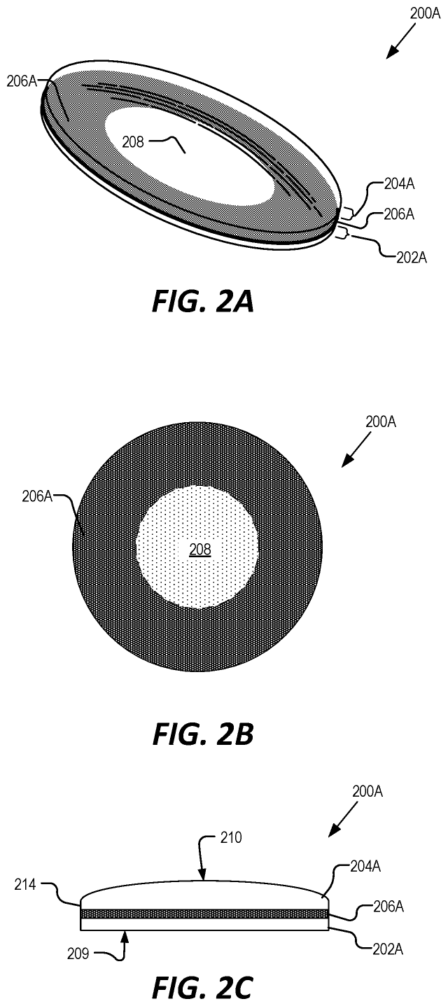

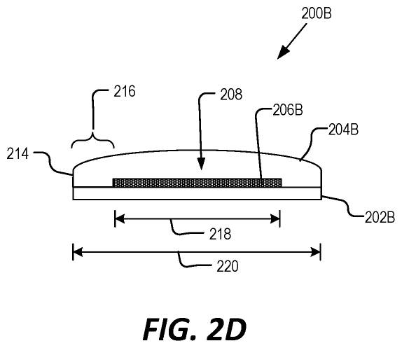

By way of example, FIGS. 2A-2C illustrate various views of a lens 200A that is fabricated to include an internal aperture element 206A, in accordance with aspects of the present disclosure. FIG. 2D illustrates another example lens 200B that includes an internal aperture element 206B. The illustrated example of lens 200A is shown as including a first region 202A, a second region 204A, and internal aperture element 206A. Lens 200B, of FIG. 2D, is shown as including a first region 202B, a second region 204B, and internal aperture element 206B. Lenses 200A and 200B are possible examples of a near-eye optical element that may be incorporated into the optical assembly of the viewing structure 140 of FIG. 1. Lenses 200A and 200B may also be possible examples of a small-diameter optical element that may be incorporated into the optical assembly that is utilized with the electronic component 145 of FIG. 1.

Referring to FIG. 2A, the first region 202A and the second region 204A of the lens 200A are formed from an optically-transmissive material, such as a polymer, resin, or glass (e.g., silica). As will be described in more detail below, the first region 202A and the second region 204A may be fabricated as a single monolithic structure of the optically-transmissive material such that the internal aperture element 206A is integrally disposed between the first region 202A and the second region 204A. In some embodiments, the first region 202A and the second region 204A have the same refractive index (e.g., 1.4 to 1.6). In other examples, the first region 202A may be configured to have a refractive index that is different from the refractive index of the second region 204A.

In some embodiments, both the first region 202A and the second region 204A are formed from a polymer or resin. In another embodiment, both the first region 202A and the second region 204A are formed from glass. In yet another embodiment, one of the regions is glass, where the other region is formed from a polymer or resin (e.g., first region 202A may be glass where second region 204A is a polymer or resin that is formed over the glass first region 202A).

As shown in FIG. 2A, the internal aperture element 206A is configured to define an aperture 208 of the lens 200A. The internal aperture element 206A may be an opaque label or sticker that is suspended within the optically-transmissive material that is used to form the lens 200A. In another example, the internal aperture element 206A is an ink, a blackened aluminum, a copper black, or other coating that is applied during the fabrication of the lens 200A, such that the coating is suspended within the optically-transmissive material. As shown in FIG. 2B, internal aperture element 206A may have an annular or ring-shape. In other examples, internal aperture element 206A may have a shape that is configured to conform to a peripheral shape of the lens 200A (e.g., lens 200A may be circular, non-circular, square, oval, etc.). In some aspects, aperture 208, provided by the internal aperture element 206A, does not conform to the peripheral shape of the lens 200A. By way of example, lens 200A may be a square-shaped lens, whereas the internal aperture element 206A may provide a circular-shaped aperture 208A.

Referring now to FIG. 2C, the first region 202A is shown as being configured to define a first surface 209 of the lens 200A, and the second region 204A is configured to define a second surface 210 that is opposite the first surface 209. In some examples, first surface 209 and second surface 210 are the outer-most surfaces of the lens 200A. Although FIG. 2C illustrates the first surface 209 as being substantially planar and the second surface 210 as having a curvature, in other embodiments both the first and second surfaces may have a curvature. In other examples, both the first and second surfaces 209/210 may be substantially planar. In some examples, the first surface 209 has a curvature that is different from the curvature of the second surface 210. In some embodiments, one or more of the first surface 209 and the second surface 210 have a curvature that corresponds to the specifications of a user. In other words, the lens 200A may be a prescription lens. In some aspects, the curvature of the first surface 209 and/or the second surface 210 are constant across the surface such that the lens 200A may be referred to as a spherical lens. In other embodiments, lens 200A may be an aspherical lens where the curvature varies over the first surface 209 and/or varies over the second surface 210.

As shown in FIG. 2C, lens 200A includes an internal aperture element 206A that extends to the side-edge 214 of the lens 200A. In some aspects, having internal aperture element 206A extend all the way to side-edge 214 allows for lens 200A to be in direct contact with another optical element (e.g., another lens) while using one or more interlocking features. By way of example, in some implementations the first region 202A and/or second region 204A may include an interlocking feature (not shown in FIG. 2C) for mating the lens 200A with another optical element. Such interlocking features may include mechanical alignment features (e.g., protrusions and/or grooves) for mating with another alignment feature of a successive optical element for optically aligning the two elements together. In some optical assemblies the aperture is required to extend to the inner diameter of the housing/barrel to prevent stray light. However, as mentioned above, conventional aperture stops included in conventional optical assemblies are typically provided as separate and discrete optical elements. Having an aperture stop as a separate and discrete element that extends to all the way to the inner diameter of the housing/barrel may prevent or interfere with such interlocking features. Accordingly, having an internal aperture element, such as internal aperture element 206A of FIG. 2C, allows for the inclusion of one or more interlocking features to be incorporated into the first region 202A and/or second region 204A for lens-to-lens contact, while simultaneously blocking stray light at the side-edge 214.

However, in some embodiments a lens may be fabricated to include an internal aperture element that does not extend to the side-edge 214. By way of example, FIG. 2D illustrates a lens 200B that includes an internal aperture element 206B that stops short of the side-edge 214. In particular, internal aperture element 206B is shown as having a width 218 that is less than a width 220 of the lens 200B. In one some implementations, lens 200B may be utilized simultaneously by multiple optical systems. By way of example, lens 200B may be configured to direct light through aperture 208, provided by the internal aperture element 206B, to a first optical system (e.g., a first image sensor). In addition, light that passes through the region 216 (i.e., between the internal aperture element 206B and the side-edge 214) may be utilized by a different optical system, such as another image sensor, a depth sensor, light detector, or other feedback device.

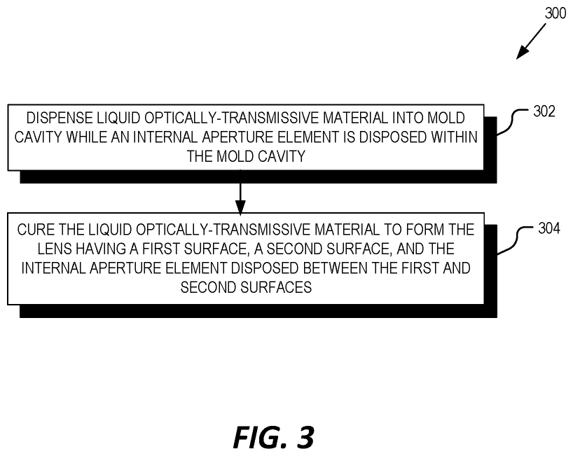

FIG. 3 is a flow chart illustrating an example process 300 of fabricating a lens with an internal aperture, in accordance with aspects of the present disclosure. Process 300 is one possible process of fabricating lens 200A and/or 200B of FIGS. 2A-2D. In a process block 302, a liquid optically-transmissive material is dispensed into a mold cavity. The liquid optically-transmissive material is dispensed into the mold cavity while an internal aperture element (e.g., internal aperture element 206A of FIGS. 2A-2C) is disposed within the mold cavity. In some examples, the liquid optically-transmissive material is a curable material, such as a plastic, resin, poly-methyl methacrylate (PMMA), acrylic, or polymer. In some embodiments, dispensing the liquid optically-transmissive material is part of a casting process that includes pouring the liquid optically-transmissive material into the mold cavity. In another embodiment, dispensing the liquid optically-transmissive material is part of an injection-molding process that includes injecting the liquid optically-transmissive material into the mold cavity.

In a process block 304, the liquid optically-transmissive material is then cured to form a lens (e.g., lens 200A) having a first surface (e.g., first surface 209), a second surface (e.g., second surface 210), where the internal aperture element 206A is disposed (i.e., suspended) between the first and second surfaces. Curing the liquid optically-transmissive material includes transforming the material into a solid state to form the lens. In some examples, process block 304 includes a thermal curing process, such as a fast-curing or a snap-curing process that includes the application of heat to the liquid optically-transmissive material, either directly or via the mold cavity. In other examples, the process involves cycling the temperature of the mold cavity. For example, the mold cavity may be pre-heated as a hot polymer melt is injected into the mold cavity, where mold cavity is then actively cooled after the cavity has been filled. Only then is the part temperature reduced to the level required for curing. In some aspects, this process of cycling the temperature of the mold cavity may require less injection pressure and/or clamping force and may also reduce internal stress during injection. In yet another example, process block 304 includes an ultra-violet (UV) curing process that involves illuminating the liquid optically-transmissive material to initiate a photochemical reaction.

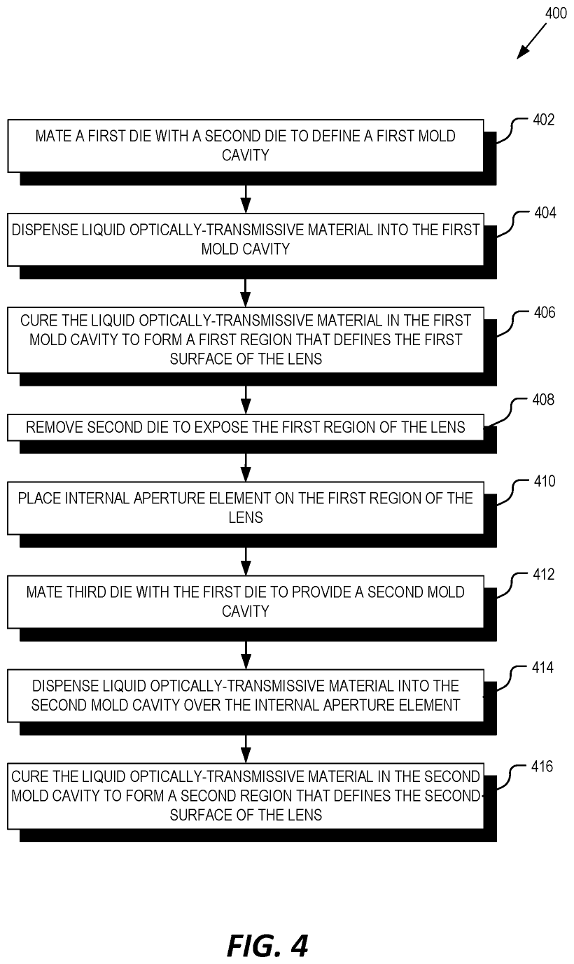

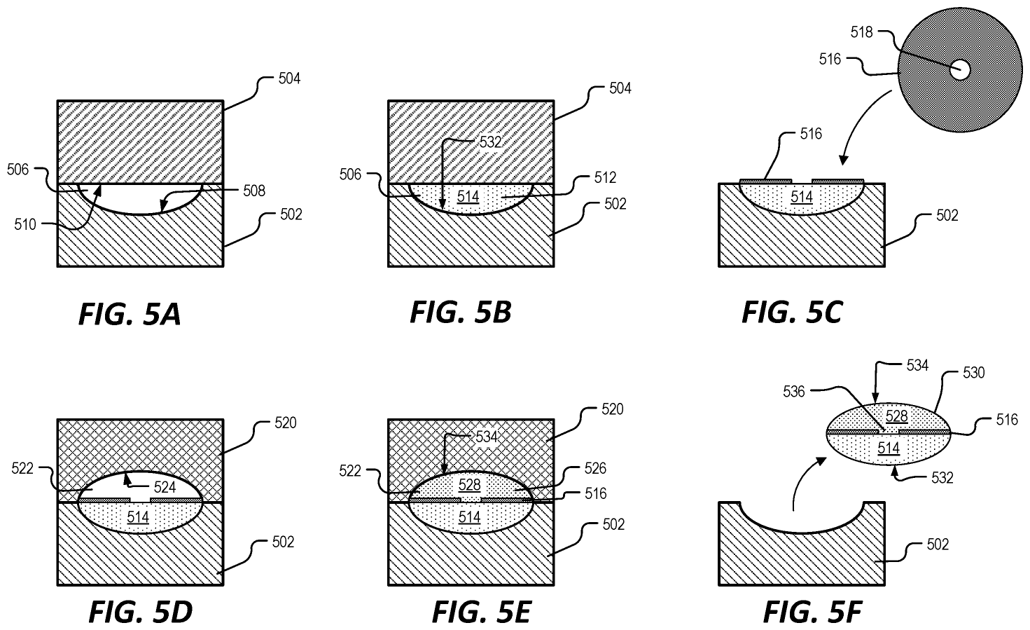

FIG. 4 is a flow chart illustrating an example two-shot process 400 of fabricating a lens with an internal aperture element, in accordance with aspects of the present disclosure. The two-shot process 400 is one possible example that illustrates additional fabrication details of process 300 of FIG. 3, while FIGS. 5A-5F illustrate an example implementation of the two-shot process 400 of FIG. 4. Process 400 will be described with reference to both FIG. 4 and FIGS. 5A-5F, but in some examples, process 400 may be performed without one or more of the specific implementation details provided in FIGS. 5A-5F.

In a process block 402, a first die 502 is mated with a second die 504 to define a mold cavity 506. As shown in FIG. 5A, the first die 502 includes a first lens-forming surface 508 and the second die 504 includes a second surface 510. In some examples, the second surface 510 is substantially planar. However, in other examples, the second surface 510 may be a second lens-forming (e.g., optical) surface having a curvature. Next, in process block 404, a liquid optically-transmissive material 512 is dispensed into the mold cavity 506 (see FIG. 5B). As discussed above, dispensing the liquid optically-transmissive material 512 may include pouring the liquid optically-transmissive material 512 into the mold cavity 506 (e.g., casting) or it may include injecting the liquid optically-transmissive material 512 (e.g., injection molding). In some implementations, the first die 502 and/or the second die 504 may be heated prior to dispensing the liquid optically-transmissive material 512 into the mold cavity 506.

Process block 406 then includes curing the liquid optically-transmissive material 512 in the mold cavity 506 to form a first region 514 of a lens. As discussed above, curing the liquid optically-transmissive material 512 may include a thermal curing process that includes actively cooling one or more of the first and second dies 502/504. In other examples, curing the liquid optically-transmissive material 512 may include a UV curing process where one or more of the first and second dies 502/504 are transmissive to UV light (e.g., second die 504 may be glass or other UV transparent material).

As shown in FIG. 5B, the first region 514 is configured to define a first surface 532 of the lens that conforms to the first lens-forming surface 508 of the first die 502. Next, in process block 408, the second die 504 is removed to expose the first region 514 of the lens. As shown in FIG. 5C, an internal aperture element 516 is then placed on the exposed first region 514 (i.e., process block 410). As mentioned above, the internal aperture element 516 may be an opaque label or sticker that is applied to the first region 514 (e.g., after the liquid optically-transmissive material 512 has cured). In another example, the internal aperture element 516 is an ink, a blackened aluminum, a copper black, or other coating that is applied to the first region 514 while the first region 514 exposed. As shown in FIG. 5C, internal aperture element 516 may have an annular or ring-shape that includes a hole 518 that defines an aperture of the lens.

Process block 412 includes mating a third die 520 with the first die 502 to provide a mold cavity 522. As shown in FIG. 5D, the third die 520 includes a third lens-forming surface 524. As illustrated in FIG. 5E, a liquid optically-transmissive material 526 is then dispensed into the mold cavity 522 over the internal aperture element 516 (e.g., process block 414). The liquid optically-transmissive material 526 may be the same material as liquid optically-transmissive material 512, discussed above with respect to FIG. 5B. Alternatively, liquid optically-transmissive material 526 may have different optical characteristics, such as a different refractive index, different corresponding light wavelength or corresponding temperature for curing, or other difference. For example, the hardening/curing process for liquid optically-transmissive material 512 and that for the liquid optically-transmissive material 526 may be different (e.g., one could be injection molded plastic, solidified by cooling, whereas the other could be a UV curable material that is hardened by exposure to UV light and/or thermal environments).

Process block 416 then includes curing the liquid optically-transmissive material 526 in the mold cavity 522 to form a second region 528 of the lens. Curing the liquid optically-transmissive material 526 may include a thermal curing process that includes actively cooling one or more of the first and third dies 502/520. In other examples, curing the liquid optically-transmissive material 526 may include a UV curing process where one or more of the first and third dies 502/520 are transmissive to UV light (e.g., third die 520 may be glass or other UV transparent material).

As shown in FIG. 5E, the second region 528 is configured to define a second surface 534 of the lens that conforms to the third lens-forming surface 524 of the third die 520. FIG. 5F illustrates the lens 530 removed from the first die 502 after the second region 528 has cured. As shown in FIG. 5F, lens 530 includes a first surface 532 provided by the first region 514, a second surface 534 provided by the second region 528, where the internal aperture element 516 is disposed (e.g., suspended) between the first and second regions 514/528. FIG. 5F also illustrates an aperture 536 of lens 530 that is provided by the internal aperture element 516.

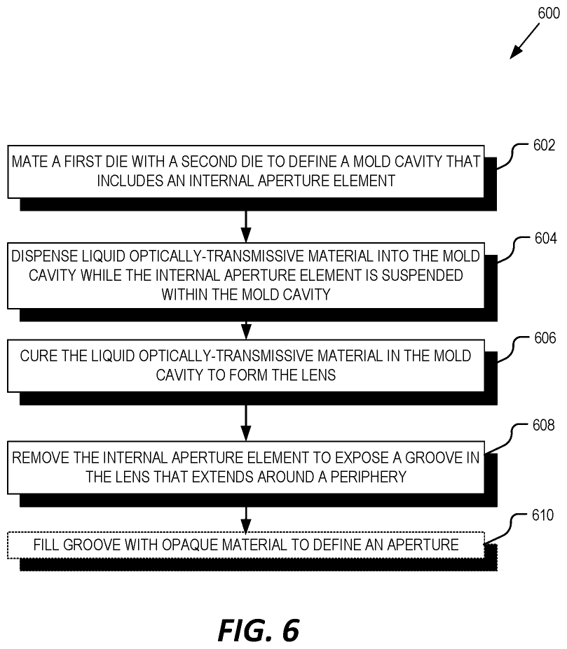

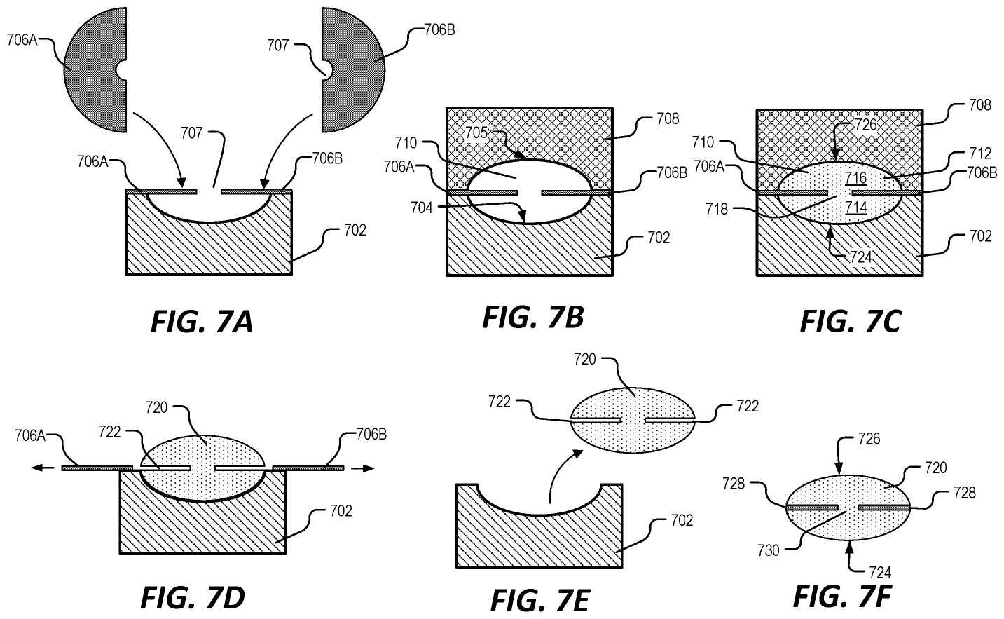

FIG. 6 is a flow chart illustrating an example one-shot process 600 of fabricating a lens utilizing a removable internal aperture element, in accordance with aspects of the present disclosure. The one-shot process 600 is one possible example that illustrates additional fabrication details of process 300 of FIG. 3, while FIGS. 7A-7F illustrate an example implementation of the one-shot process 600 of FIG. 6. Process 600 will be described with reference to both FIG. 6 and FIGS. 7A-7F, but in some examples, process 600 may be performed without one or more of the specific implementation details provided in FIGS. 7A-7F.

First, FIG. 7A illustrates two removable slides 706A and 706B, collectively referred to herein as internal aperture element 706. The internal aperture element 706 is configured to be placed (e.g., suspended) within a mold cavity while liquid optically-transmissive material is being dispensed within the mold cavity. The internal aperture element 706 is also configured to be removed once the liquid optically-transmissive material is cured to expose a groove in the lens, which may be subsequently filled with an opaque material to form an aperture of the lens. Although FIG. 7A illustrates internal aperture element 706 as including two slides 706A and 706B, any number of slides may be used to form the internal aperture element 706 including two or more. When mated together, the slides 706A and 706B form a hole 707, which will define the resultant aperture of the lens. Slides 706A and 706B may metal, glass, or other thin rigid structure.

Turning now to process 600 of FIG. 6, process block 602 includes mating a first die 702 with a second die 708 to define a mold cavity 710 that includes internal aperture element 706. As shown in FIG. 7B, the internal aperture element 706, including slides 706A and 706B, is disposed within the mold cavity 710. FIG. 7B also illustrates the first die 702 as including a first lens-forming surface 704 and the second die 708 as including a second lens-forming surface 705.

Next, in process block 604, a liquid optically-transmissive material 712 is dispensed into the mold cavity 710 (see FIG. 7C). Dispensing the liquid optically-transmissive material 712 may include pouring the liquid optically-transmissive material 712 into the mold cavity 710 (e.g., casting) or it may include injecting the liquid optically-transmissive material 712 (e.g., injection molding). In some implementations, the first die 702 and/or the second die 708 may be heated prior to dispensing the liquid optically-transmissive material 712 into the mold cavity 710.

Process block 606 then includes curing the liquid optically-transmissive material 712 in the mold cavity 506 to form both a first region 714 and a second region 716 of a lens. Curing the liquid optically-transmissive material 712 may include a thermal curing process and/or a UV curing process.

As shown in FIG. 7C, the first region 714 is configured to define a first surface 724 of the lens that conforms to the first lens-forming surface 704 of the first die 702. Similarly, the second region 716 is configured to define a second surface 726 of the lens that conforms to the second lens-forming surface 705 of the second die 708. Next, in process block 608, the second die 708 is removed to expose the cured lens 720 and the internal aperture element 706 is removed to expose a groove 722 (e.g., see FIG. 7D). In some examples, groove 722 extends around a periphery of the lens 720 and has a thickness that corresponds to the thickness of the slides 706A/706B. FIG. 7E illustrates the lens 720 removed from the first die 702.

Next, in optional process block 610, and as shown in FIG. 7F, the groove 722 may be filled with an opaque material 728 to define an aperture 730 of the lens 720. The opaque material may include an ink, a blackened aluminum, a copper black, or other coating that is placed within the groove 722.

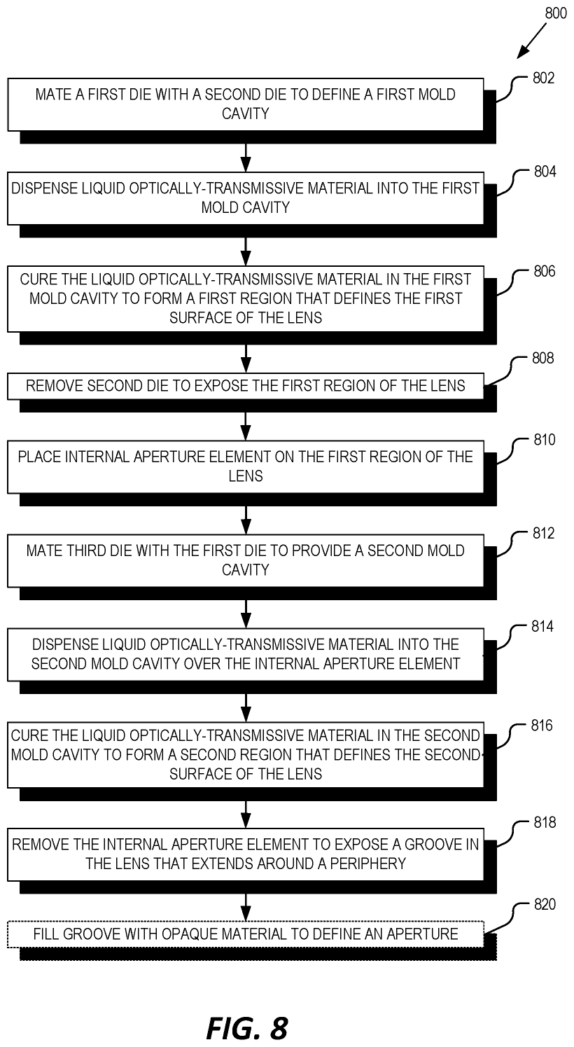

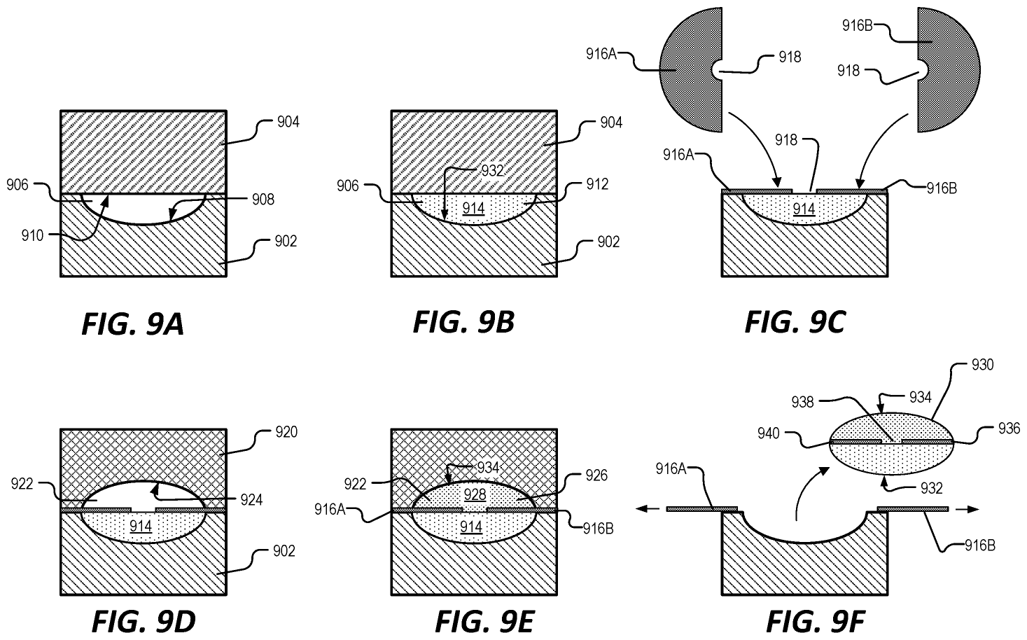

FIG. 8 is a flow chart illustrating an example two-shot process 800 of fabricating a lens utilizing a removable internal aperture element, in accordance with aspects of the present disclosure. The two-shot process 800 is one possible example that illustrates additional fabrication details of process 300 of FIG. 3, while FIGS. 9A-9F illustrate an example implementation of the two-shot process 800 of FIG. 8. Process 800 will be described with reference to both FIG. 8 and FIGS. 9A-9F, but in some examples, process 800 may be performed without one or more of the specific implementation details provided in FIGS. 9A-9F.

In a process block 802, a first die 902 is mated with a second die 904 to define a mold cavity 906. As shown in FIG. 9A, the first die 902 includes a first lens-forming surface 908 and the second die 904 includes a second surface 910. In some examples, the second surface 910 is substantially planar. However, in other examples, the second surface 910 may be a second lens-forming (e.g., optical) surface having a curvature. Next, in process block 804, a liquid optically-transmissive material 912 is dispensed into the mold cavity 906 (see FIG. 9B). As discussed above, dispensing the liquid optically-transmissive material 912 may include pouring the liquid optically-transmissive material 912 into the mold cavity 906 (e.g., casting) or it may include injecting the liquid optically-transmissive material 912 (e.g., injection molding). In some implementations, the first die 902 and/or the second die 904 may be heated prior to dispensing the liquid optically-transmissive material 912 into the mold cavity 906.

Process block 806 then includes curing the liquid optically-transmissive material 912 in the mold cavity 906 to form a first region 914 of a lens. As discussed above, curing the liquid optically-transmissive material 912 may include a thermal curing process that includes actively cooling one or more of the first and second dies 902/904. In other examples, curing the liquid optically-transmissive material 912 may include a UV curing process where one or more of the first and second dies 902/904 are transmissive to UV light (e.g., second die 904 may be glass or other UV transparent material).

As shown in FIG. 9B, the first region 914 is configured to define a first surface 932 of the lens that conforms to the first lens-forming surface 908 of the first die 902. Next, in process block 808, the second die 904 is removed to expose the first region 914 of the lens. As shown in FIG. 9C, slides 916A and 916B (collectively referred to herein as internal aperture element 916) are then placed on the exposed first region 914 (i.e., process block 810). As mentioned above, the internal aperture element 916 may be rigid structure that provides a hole 918 corresponding to a desired aperture for the lens.

Process block 812 includes mating a third die 920 with the first die 902 to provide a mold cavity 922. As shown in FIG. 9D, the third die 920 includes a third lens-forming surface 924. As illustrated in FIG. 9E, a liquid optically-transmissive material 926 is then dispensed into the mold cavity 922 over the internal aperture element 916 (e.g., process block 814). The liquid optically-transmissive material 926 may be the same material as liquid optically-transmissive material 912, discussed with respect to FIG. 9B. Alternatively, liquid optically-transmissive material 926 may have different optical characteristics, such as a different refractive index, different corresponding light wavelength or corresponding temperature for curing, or other difference.

Process block 816 then includes curing the liquid optically-transmissive material 926 in the mold cavity 922 to form a second region 928 of the lens. Curing the liquid optically-transmissive material 926 may include a thermal curing process that includes actively cooling one or more of the first and third dies 902/920. In other examples, curing the liquid optically-transmissive material 926 may include a UV curing process where one or more of the first and third dies 902/920 are transmissive to UV light (e.g., third die 920 may be glass or other UV transparent material).

As shown in FIG. 9E, the second region 928 is configured to define a second surface 934 of the lens that conforms to the third lens-forming surface 924 of the third die 920. FIG. 9F illustrates the removal of the internal aperture element 916 (i.e., process block 818) and the removal of the lens 930 from the first die 902 after the second region 928 has cured. As shown in FIG. 9(f), removal of the internal aperture element 916 exposes a groove 936 that is formed in the lens 930. In an optional process block 820, groove 936 may be filled with an opaque material 940 to define an aperture 938 of the lens 930. The opaque material may include an ink, a blackened aluminum, a copper black, or other coating that is placed within the groove 936.

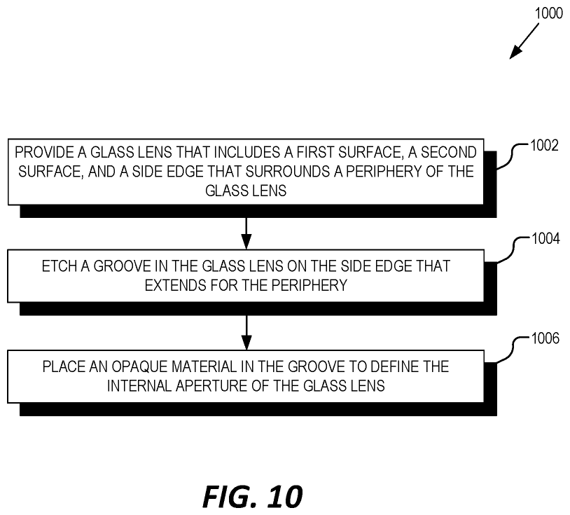

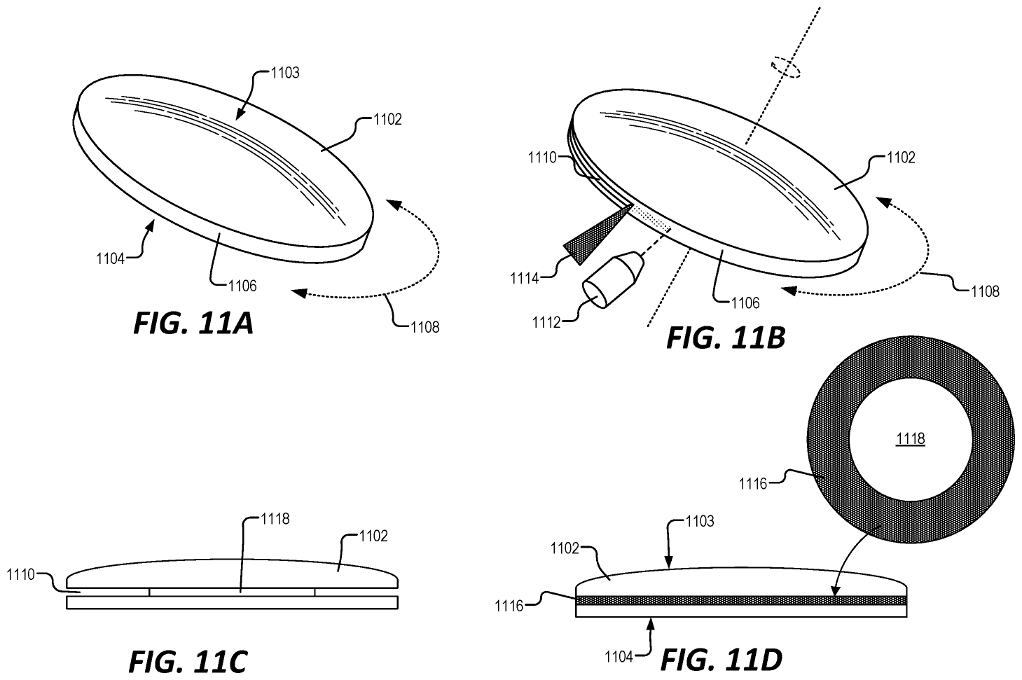

The above-described processes 300, 400, 600, and 800 provide example procedures of forming a lens that includes an internal aperture, such as lens 200A of FIGS. 2A-2C. Processes 300, 400, 600, and 800 describe forming such a lens using a liquid optically-transmissive material, such as a resin or polymer. However, as stated above, lens 200A may alternatively be a glass lens. Accordingly, FIG. 10 provides a flow chart illustrating an example process 1000 of fabricating an internal aperture for a glass lens, in accordance with aspects of the present disclosure. The process 1000 is one possible example process of fabricating the lens 200A of FIG. 2A, while FIGS. 11A-11D illustrate an example implementation of process 1000. Process 1000 will be described with reference to both FIG. 10 and FIGS. 11A-11D, but in some examples, process 1000 may be performed without one or more of the specific implementation details provided in FIGS. 11A-11D.

In a process block 1002, a glass lens 1102 is provided. As shown in FIG. 11A, the glass lens 1102 includes a first surface 1103 (e.g., top surface as shown in FIG. 11A) and a second surface 1104 (e.g., bottom surface as shown in FIG. 11A) that is opposite the first surface 1103. Glass lens 1102 is also shown as including a side edge 1106 that surrounds a periphery 1108 of the glass lens 1102. In some examples, glass lens 1102 is fused quartz, fused silica or other high-performance optical material.

In some aspects, the first surface 1103 and/or the second surface 1104 may have a curvature. In some embodiments, the first surface 1103 has a curvature that is different from the curvature of the second surface 1104. In some embodiments, one or more of the first surface 1103 and the second surface 1104 have a curvature that corresponds to the specifications of a user. In other words, the glass lens 1102 may be a prescription lens.

Returning now to FIG. 10, process block 1004 includes etching a groove in the glass lens on the side edge. For example, FIG. 11B illustrates a groove 1110 that is etched in the glass lens 1102 on the side edge 1106. In some implementations, etching the groove 1110 may include a laser-assisted diamond turning process to form the groove 1110. By way of example, FIG. 11B illustrates a laser-assisted diamond turning process that utilizes a laser 1112 and a cutting tool 1114. As shown in FIG. 11B, the laser 1112 may emit a beam of light onto the side edge 1106 to heat and soften a region of the side edge 1106, where the cutting tool 1114 then removes the softened material to form the groove 1110. However, in other embodiments, groove 1110 may be formed by a laser ablation process to weaken/damage the periphery 1108 of the glass lens 1102, followed by a chemical or other etching process to remove the damaged material to create the groove 1110. In some aspects, the groove 1110 is formed to extend for the entire periphery 1108 of the glass lens 1102.

FIG. 11C illustrates a side-view of the glass lens 1102 after the groove 1110 has been formed. As shown in FIG. 11C, after the groove 1110 is etched a portion of material remains in the center region of the lens, which will serve as the aperture 1118 of the glass lens 1102.

With reference to FIG. 10, process block 1006 includes placing an opaque material in the groove to define the internal aperture of the glass lens. For example, FIG. 11D illustrates opaque material 1116 that is placed (e.g., applied) within the groove 1110 to define the internal aperture 1118 of the glass lens 1102. In some examples, the opaque material 1116 is an ink, a blackened aluminum, or a copper black coating that is applied to the groove 1110.

The order in which some or all of the process blocks appear in each process 300, 400, 600, 800, and 1000, described above should not be deemed limiting. Rather, one of ordinary skill in the art having the benefit of the present disclosure will understand that some of the process blocks may be executed in a variety of orders not illustrated.

Embodiments of the invention may include or be implemented in conjunction with the manufacture of an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A lens, comprising:
a first region of optically-transmissive material that is configured to define a first surface of the lens;
a second region of optically-transmissive material that is configured to define a second surface of the lens opposite the first surface; and
an internal aperture element integrally disposed between the first region and the second region, wherein the internal aperture element is configured to define an aperture of the lens.

2. The lens of claim 1, wherein the optically-transmissive material comprises glass and wherein the first region and the second region form a single monolithic structure of glass.

3. The lens of claim 1, wherein the optically-transmissive material comprises a polymer or a resin and wherein the first region and the second region form a single monolithic structure of the polymer or the resin.

4. The lens of claim 1, wherein the internal aperture element comprises an opaque label or sticker suspended within the optically-transmissive material.

5. The lens of claim 1, wherein the internal aperture element comprises at least one of an ink, a blackened aluminum, or a copper black coating suspended within the optically-transmissive material.

6. A method of fabricating a lens, the method comprising:
dispensing a liquid optically-transmissive material into a mold cavity while an internal aperture element is disposed within the mold cavity, wherein the internal aperture element is configured to define an aperture of the lens; and
curing the liquid optically-transmissive material to form the lens having a first surface, a second surface that is opposite the first surface, and the internal aperture element disposed between the first surface and the second surface of the lens.

7. The method of claim 6, further comprising:
mating a first die with a second die to define a first mold cavity;
dispensing the liquid optically-transmissive material into the first mold cavity;
curing the liquid optically-transmissive material in the first mold cavity to form a first region that defines the first surface of the lens;
removing the second die to expose the first region of the lens;
placing the internal aperture element on the first region of the lens;
mating a third die with the first die to provide a second mold cavity;
dispensing the liquid optically-transmissive material into the second mold cavity over the internal aperture element; and
curing the liquid optically-transmissive material in the second mold cavity to form a second region that defines the second surface of the lens.

8. The method of claim 7, wherein:
the first die comprises a first lens-forming surface that defines the first surface of the lens,
the second die comprises a second surface that is opposite the first lens-forming surface when the second die is mated with the first die to provide the first mold cavity, and
the third die comprises a third lens-forming surface that defines the second surface of the lens.

9. The method of claim 7, wherein curing the liquid optically-transmissive material comprises an ultraviolet (UV) curing process that includes illuminating the liquid optically-transmissive material with UV light.

10. The method of claim 9, wherein at least one of the first die, the second die, or the third die, are transparent to the UV light.

11. The method of claim 7, wherein dispensing and curing the liquid optically-transmissive material comprises a thermal curing process that includes heating at least one of the first die, the second die, or the third die.

12. The method of claim 7, wherein the liquid optically-transmissive material comprises a polymer or a resin.

13. The method of claim 7, further comprising:
removing the internal aperture element subsequent to the curing of the liquid optically-transmissive material in the second mold cavity to expose a groove in the lens that extends around a periphery of the lens.

14. The method of claim 13, further comprising:
placing an opaque material in the groove to define the aperture of the lens.

15. The method of claim 14, wherein placing the opaque material in the groove comprises applying an ink, a blackened aluminum, or a copper black coating in the groove.

16. The method of claim 6, further comprising:
mating a first die with a second die to define the mold cavity that includes the internal aperture element, wherein the first die comprises a first lens-forming surface that defines the first surface of the lens, the second dies comprises a second lens-forming surface that defines the second surface of the lens, and wherein the internal aperture element is suspended within the mold cavity between the first lens-forming surface and the second lens-forming surface;
dispensing the liquid optically-transmissive material into the mold cavity while the internal aperture element is suspended within the mold cavity;
curing the liquid optically-transmissive material in the mold cavity to form the lens; and
removing the internal aperture element subsequent to the curing of the liquid optically-transmissive material to expose a groove in the lens that extends around a periphery of the lens.

17. The method of claim 16, further comprising:
placing an opaque material in the groove to define the aperture of the lens.

18. A method of fabricating an internal aperture for a glass lens, the method comprising:
providing the glass lens that includes:
a first surface;
a second surface that is opposite the first surface; and
a side edge that surrounds a periphery of the glass lens;
etching a groove in the glass lens on the side edge, wherein the groove extends for the periphery of the glass lens; and
placing an opaque material in the groove to define the internal aperture of the glass lens.

19. The method of claim 18, wherein placing the opaque material in the groove comprises applying an ink, a blackened aluminum, or a copper black coating in the groove.

20. The method of claim 18, wherein etching the groove in the glass lens on the side edge comprises a laser-assisted diamond turning process to form the groove on the side edge.
